(19) United States
(12) Patent Application Publication
(10) Pub. No.: US 2016/0381741 A1
(43) Pub. Date: Dec. 29, 2016

(54) MICROWAVE OVEN

(71) Applicant: Samsung Electronics Co., Ltd, Gyeonggi-do (KR)

(72) Inventors: Se-hun Lee, Gyeonggi-do (KR); Sun-ki Kim, Gyeonggi-do (KR)

(21) Appl. No.: 15/192,986

(22) Filed: Jun. 24, 2016

(30) Foreign Application Priority Data
Jun. 29, 2015 (KR) 10-2015-0091926

(51) Int. Cl. H05B 6/64; F24C 15/20

(52) U.S. Cl. CPC H05B 6/6423; F24C 15/2035

(57) ABSTRACT

A microwave oven is provided. The microwave includes a main body having a suction port formed on one side thereof. The microwave also includes a flow path formed inside the main body and connected to the suction port. The microwave further includes a filter unit arranged on the flow path. In addition, the microwave includes an exhaust grille portion configured to form a part of the main body and provided with an exhaust port formed thereon, the exhaust port configured to exhaust air that is filtered through the filter unit. The exhaust grille portion includes an opening formed on a front surface thereof for replacement of the filter unit and a door configured to at least one of open or close the opening.

### CROSS-REFERENCE TO RELATED APPLICATION(S) AND CLAIM OF PRIORITY

The present application is related to and claims priority from Korean Patent Application No. 10-2015-0091926 filed on Jun. 29, 2015 in the Korean Intellectual Property Office, the disclosure of which is incorporated herein by reference in its entirety.

### TECHNICAL FIELD

The present disclosure relates to a microwave oven, and more particularly, to a wall mount type microwave oven which permits a filter unit that is mounted therein to be easily detachable.

### BACKGROUND

In general, a wall mount type microwave oven is a cooking device which is installed on a wall of a kitchen on an upper side of a cooktop of a gas range or the like that is installed on a kitchen sink to perform both a microwave cooking function that a typical microwave oven has and a function of purifying an exhaust gas, smoke, or a cooking smell of food that is generated during cooking on the cooktop of the gas range.

Such a wall mount type microwave oven, like a general microwave oven, is configured to have a cooking chamber, in which food is cooked, and a machine room, and a flow path is provided in a main body of the wall mount type microwave oven. According to the wall mount type microwave oven, an exhaust fan is installed on an upper side of the flow path to inhale the exhaust gas, smoke, or cooking smell of food, which is generated due to the use of the gas range installed on a lower side of the main body, through a suction port that is provided on a lower portion of the main body and to make the inhaled exhaust gas, smoke, or cooking smell pass through a filter unit that is arranged on the flow path for purification. The wall mount type can maintain an air purification function through cleaning or replacement of the filter unit in a period of about 6 months.

The separation of the filter unit that is installed in the wall mount type microwave oven in the related art is as follows. First, a grille is separated from the main body after removal of screws that fix the grille to the main body. Then, the filter unit is taken out of the main body to be cleaned or replaced.

However, the wall mount type microwave oven in the related art has the drawback that it is required to separate the grille from the main body in the process of separating the filter unit from the main body to cause inconvenience in working. Further, since the work to separate a plurality of screws may not be easy, the maintenance and repair thereof may be unable to be performed smoothly.

In addition, if a worker omits fixing of the grille to the main body through the screws by mistake when reassembling the grille with the main body after replacement of the filter unit, the grille may drop from the main body to be damaged or to hurt a user during the use of the gas range. Accordingly, there is a need for schemes to improve this.

### SUMMARY

To address the above-discussed deficiencies, it is a primary object to provide, for use in a wall mount type microwave oven which permits a filter unit that is arranged on a flow path to be replaced without separating an exhaust grille portion from a main body of the microwave oven to improve user convenience.

In a first embodiment, a microwave oven is provided. The microwave oven includes a main body having a suction port formed on one side thereof. The microwave oven also includes a flow path formed inside the main body and connected to the suction port. The microwave oven further includes a filter unit arranged on the flow path. In addition, the microwave oven includes an exhaust grille portion configured to form a part of the main body and provided with an exhaust port formed thereon, the exhaust port configured to exhaust air that is filtered through the filter unit. The exhaust grille portion includes an opening formed on a front surface thereof for replacement of the filter unit and a door configured to open or close the opening.

The door may have left and right ends that are hinge-connected to a front cover of the exhaust grille portion to open/close the opening in an opening/closing manner. Hinge shafts provided at the left and right ends of the door may be rotatably coupled to an upper side or a lower side of the front cover, and a hook provided on an inner side surface of the door may be locked in or unlocked from a latch member provided on the front cover.

The door may be slidably coupled to a front cover of the exhaust grille portion to open/close the opening in a sliding manner. The flow path may include a filter unit mount portion configured to support the filter unit to be slantingly arranged, and the filter unit mount portion may include a catching ledge configured to support a lower end portion of the filter unit; and a pair of support projections formed in a position that is higher than the catching ledge to support both sides of the filter unit. The pair of support projections may extend slantingly in a rib shape. The pair of support projections may include bent portions formed on upper ends thereof to be bent forward to prevent the filter unit from seceding backward. The filter unit may include a filter frame having an opening formed in a center portion thereof, a filter installed on the opening of the filter frame, and a handle formed to extend from the filter frame.

In a second embodiment, a microwave oven includes a main body having a suction port and an exhaust portion formed thereon. The microwave oven also includes a flow path formed inside the main body to connect the suction port and the exhaust portion to each other. The microwave oven further includes a filter unit arranged on the flow path. The main body includes an opening formed on a part of a front surface of the main body that is adjacent to the exhaust port to replace the filter unit and a door configured to open or close the opening.

The door may have left and right ends that are hinge-connected to the periphery of the opening to open/close the opening in an opening/closing manner, or may be slidably coupled to the periphery of the opening to open/close the opening in a sliding manner. A filter unit mount portion formed in the flow path may include a catching ledge configured to support a lower end portion of the filter unit; and a pair of support projections extending slantingly in a rib shape to support both sides of the filter unit, wherein the pair of support projections include bent portions formed on upper ends thereof to be bent forward. The filter unit may further include a handle formed on one portion thereof to draw out the filter unit through the opening.

Additional and/or other aspects and advantages of the disclosure will be set forth in part in the description which follows and, in part, will be obvious from the description, or may be learned by practice of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view illustrating a wall mount type microwave oven according to an embodiment of the present disclosure;

FIG. 2 is a perspective view explaining a flow path of the wall mount type microwave oven illustrated in FIG. 1;

FIG. 3 is a plan view explaining a flow path of the wall mount type microwave oven illustrated in FIG. 1;

FIG. 4 is an enlarged perspective view illustrating a filter unit, a filter unit mount portion, and an exhaust grille portion illustrated in FIG. 1;

FIG. 5 is a perspective view illustrating an exhaust grille portion illustrated in FIG. 1;

FIGS. 6 and 7 are perspective views illustrating exhaust grille portions according to various embodiments;

FIG. 8 is an enlarged perspective view illustrating a filter unit mount portion formed in a flow path;

FIG. 9 is a perspective view illustrating a filter unit mount portion according to another embodiment;

FIGS. 10A, 10B, and 10C are views explaining mounting of a filter unit on the filter unit mount portion illustrated in FIG. 9;

FIG. 11 is a perspective view illustrating a filter unit illustrated in FIG. 1;

FIG. 12 is a perspective view illustrating a filter unit according to another embodiment; and

FIGS. 13, 14, 15, 16, and 17 are views explaining replacement of a filter unit.

### DETAILED DESCRIPTION

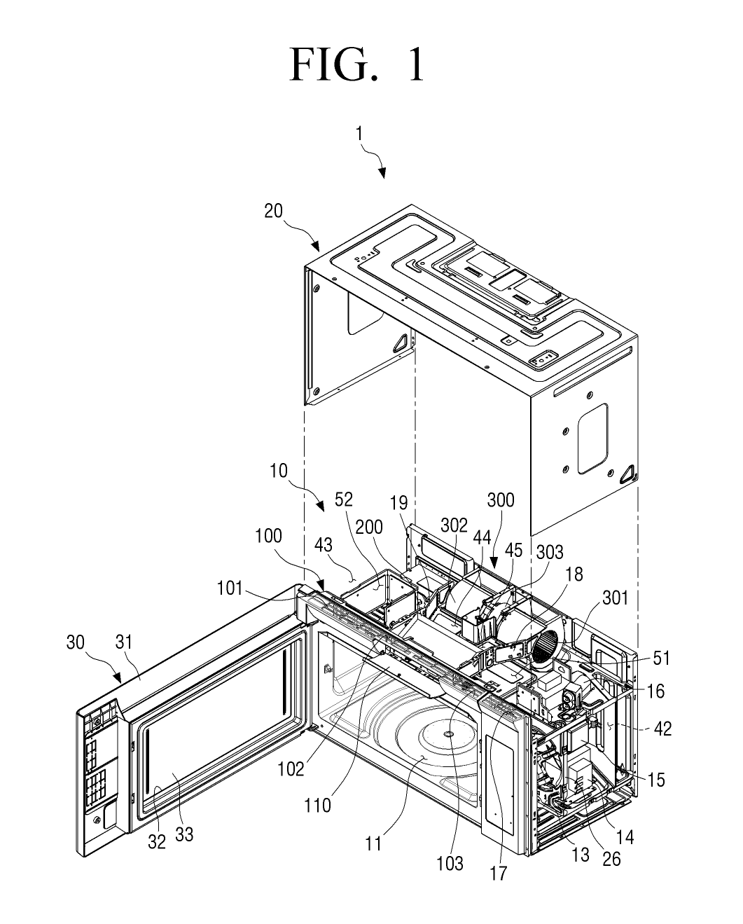

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged microwave oven. Hereinafter, exemplary embodiments of the present disclosure will be described in detail with reference to the accompanying drawings. The embodiments described hereinafter are exemplary in order to help understanding of the present disclosure, and it should be understood that the present disclosure can be variously modified differently from the embodiments described hereinafter. However, in describing the embodiment of the present disclosure, a detailed description of known constructions or functions will be omitted if it is deemed that such description would make the gist of the present disclosure unnecessarily vague. Further, in the drawings, to help the understanding of the present disclosure, sizes of some constituent elements may be exaggerated for clarity in explanation.

A wall mount type microwave oven 1 according to an embodiment of the present disclosure will be described with reference to FIG. 1. FIG. 1 is a perspective view illustrating a wall mount type microwave oven 1 according to an embodiment of the present disclosure.

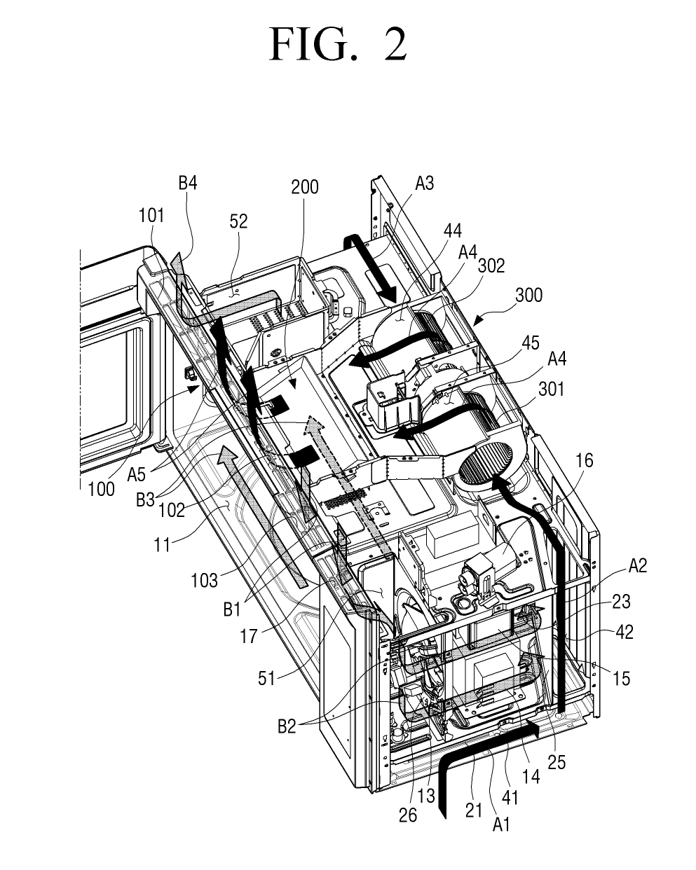

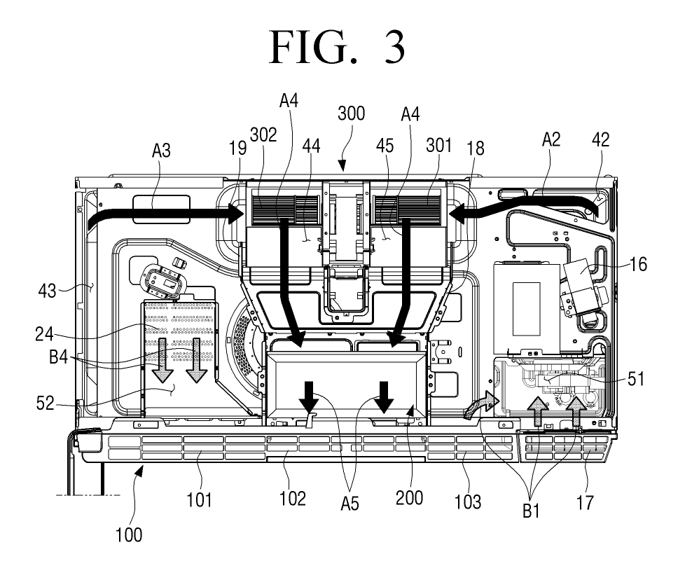

Referring to FIG. 1, the wall mount type microwave oven 1 includes a main body 10, an outer case 20, and a front door 30. The main body 10 includes a cooking chamber 11 provided in a center portion of the main body 10 to cook food therein, a machine room 13 in which various kinds of electrical components are mounted, a flow path formed inside the main body 10, and an exhaust grille portion 100. The cooking chamber 11 is formed to be opened toward a front of the main body 10 and to be opened/closed by the front door 30 to be described later. Further, a side vent hole 23 (see FIGS. 2 and 3) that is connected to the machine room 13 may be formed on a side surface of the cooking chamber 11, and an upper vent hole 24 (see FIGS. 2 and 3) that is connected to an exhaust flow path 52 to be described later may be formed on an upper surface of the cooking chamber 11.

In the machine room 13, electrical components, such as a magnetron 15 configured to supply microwaves into the cooking chamber 11, a high-voltage transformer 14 and a capacitor 16 configured to apply a high voltage to the magnetron 15, are provided. As described above, the side vent hole 23 may be formed on the side surface of the machine room 13 to communicate with the cooking chamber 11, and a part of an upper side of the machine room 13 may be formed to be opened so as to be connected to a suction flow path 51 to be described later.

In the exhaust grille portion 100, a first exhaust port 102 arranged on an upper end portion of the main body 10 to exhaust air in a first upper flow path 44 and a second upper flow path 45 to an outside, a second exhaust port 101 configured to exhaust air in the exhaust flow path 52 to the outside, and a first upper suction port 17 configured to inhale air from the outside and to guide the inhaled air to the suction flow path 51 may be formed. Further, the exhaust grille portion 100 may include a front cover 120 formed on the front surface thereof and having an opening 104 formed on the front cover 120 to replace the filter unit 200, and a door 110 configured to open/close the opening 104 formed on the front cover 120. The details thereof will be described later.

The outer case 20 may be formed in a reverse “U” shape that surrounds the upper portion and both side surfaces of the main body 10. As described above, the outer case 20 is engaged with the main body 10 to complete the flow path formed in the main body 10. The front door 30 may be rotatably coupled to one side of the main body 10 in a side swing door open type. The front door 30 is in a rectangular shape, and may include a door frame 31 having the opening 32 formed in the center portion of the door frame 31, and a tempered glass portion 33 installed on the opening 32 of the door frame 31. The front door 30 may be formed to open/close the cooking chamber 11, and if the front door 30 closes the cooking chamber 11, an inner surface of the front door 30 makes the exhaust grille portion 100 may come in partial contact with the front cover 120.

The flow path of the wall mount type microwave oven 1 of FIG. 1 will be described in detail with reference to FIGS. 2 and 3. FIG. 2 is a perspective view explaining a flow path of the wall mount type microwave oven illustrated in FIG. 1, and FIG. 3 is a plan view explaining a flow path of the wall mount type microwave oven illustrated in FIG. 1.

Referring to FIGS. 2 and 3, the flow path may include a purification flow path configured to exhaust polluted air that is polluted by gas and smoke generated through the use of the cooking device that is installed on the lower side of the wall mount type microwave oven 1, and a cooling flow path configured to cool the electrical components in the machine room 13 and to perform ventilation of the cooking chamber 11 through making an external air circulate through the inside of the machine room 13 and the inside of the cooking chamber 11.

The purification flow path may be formed through a lower portion, both side portions, and an upper portion of the main body 10. The purification flow path may include a lower flow path 41 through which external polluted air that is inhaled from a lower suction port 21 that is formed on the lower portion of the main body 10 passes as indicated by an arrow A1, first and second rising flow paths 43 and 42 through which the air in the lower flow path 41 rises as indicated by arrows A3 and A2, and first and second upper flow paths 44 and 45 which are formed on the upper portion of the main body 10 and through which the air in the first and second rising flow paths 43 and 42 is discharged to the outside as indicated by an arrow A5 after passing through a first fan portion 302 and a second fan portion 301 connected by a portion 303 of a fan motor assembly 300 as indicated by an arrow A4.

The lower flow path 41 that constitutes the purification path is provided in a separate space that is provided on the lower side of the main body, and can connect the lower suction port 21 formed on the lower portion of the main body 10 to the first and second upper flow paths 42 and 43 formed on the both side portions of the main body 10. The first rising flow path 43 that constitutes the purification flow path may be formed by one side portion of the main body 10 and one side portion of the outer case 20 that faces the one side portion of the main body 10. The second rising flow path 42 that constitutes the purification flow path may be provided on one side of the machine room 13 and may be formed to be partitioned from the machine room 13 by a blocking plate 25.

The first upper flow path 44 that constitutes the purification flow path may be formed so that the air in the first rising flow path 43 is discharged to the outside through the filter unit 200 by the first fan portion 302 of the fan motor assembly 300 installed in the center of the upper portion of the main body 10. The second upper flow path 45 that constitutes the purification flow path may be formed so that the air in the second rising flow path 42 may be formed so that the air in the second rising flow path 42 is discharged to the outside through the filter unit 200 by the second fan portion 301 of the fan motor assembly 300.

On the other hand, the cooling flow path may include the suction flow path 51 and the exhaust flow path 52 that are respectively formed on the upper portion of the main body. The suction flow path 51 that constitutes the cooling flow path may be formed so that the air that is inhaled from the outside through the first upper suction port 17 to be described later and a second upper suction port 103 of the exhaust grille portion 100 is drawn into the machine room 13 that is provided on one side of the main body 10 as indicated by an arrow B1. In this case, a cooling fan 26 may be installed in the machine room 13. Through the operation of the cooling fan 26, the external air may be inhaled through the first upper suction port 17 and the second upper suction port 103 of the exhaust grille portion 100 as indicated by arrows B2.

The exhaust flow path 52 that constitutes the cooling flow path may be formed so that the air in the suction flow path 51 cools the electrical components in the machine room 13, passes through the cooking chamber 11 as indicated by an arrow B3 after passing through the side vent hole 23, and is discharged to the outside through the second exhaust port 101 of the exhaust grille portion 100 after passing through the upper vent hole 24 of the cooking chamber 11 as indicated by an arrow B4.

Here, the first upper flow path 44 and the second upper flow path 45 may be partitioned from the space that is formed on the upper portion of the main body 10 by a first partition plate 19 and a second partition plate 18, and once the outer case is engaged with the main body 10, the purification flow path and the cooling flow path is blocked from the outside by the outer case 20 to form a complete flow path.

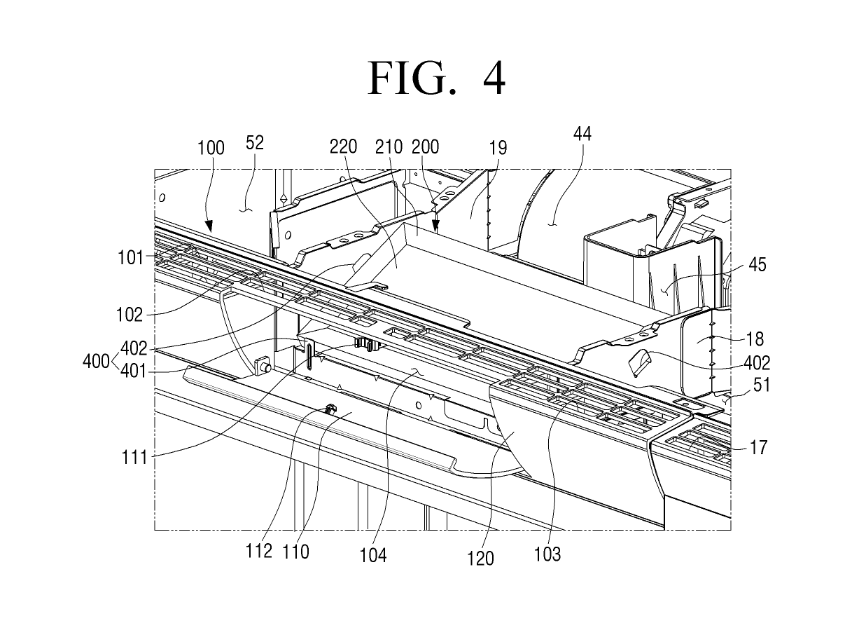

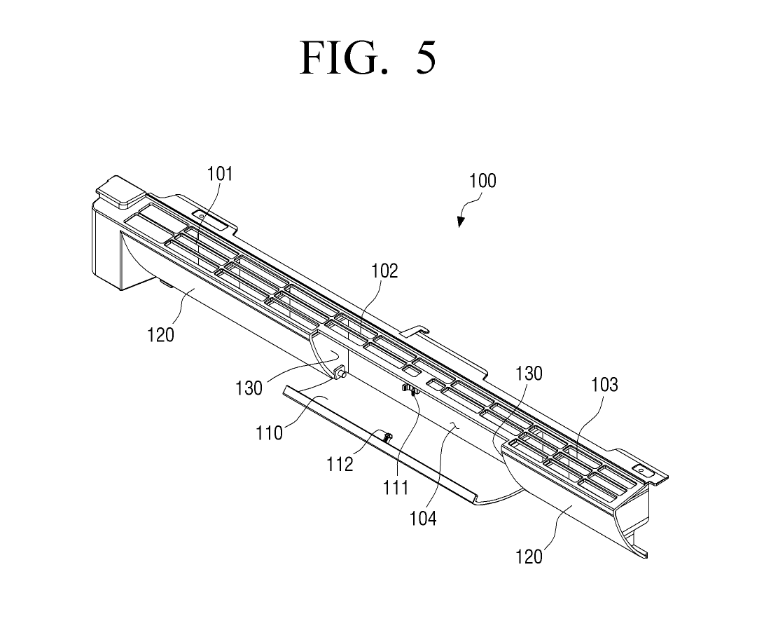

FIG. 4 is an enlarged perspective view illustrating a filter unit 200, a filter unit mount portion 400, and an exhaust grille portion 100 illustrated in FIG. 1, and FIG. 5 is a perspective view illustrating an exhaust grille portion 100 illustrated in FIG. 1. Referring to FIG. 4, the filter unit 200 may be slantingly arranged so that the air in the first upper flow path 44 and the second upper flow path 45 passes through the filter having a larger area and is discharged through the first exhaust port 102. Accordingly, the filter unit 200 can more effectively purify the polluted air that is polluted by the gas and smoke generated through the use of the cooking device installed on the lower side of the wall mount type microwave oven 1.

The filter unit mount portion 400 may include a catching ledge 401 configured to support a lower end portion of the filter frame 210 of the filter unit 200 and a pair of support projections formed in a position that is higher than the catching ledge 401 to support both sides of the filter frame 210 of the filter unit 200 so that the filter unit 200 can be slantingly arranged on the flow path. The details of the filter unit mount portion 400 will be described later.

Referring to FIGS. 4 and 5, the exhaust grille portion 100 is arranged on the upper end portion of the main body 10 to form a part of the main body 10, and may include the front cover 120, the door 110, and a plurality of vent holes formed on the upper side thereof. The front cover 120 may form the front surface of the exhaust grille portion 100 and may form a part of the front surface of the main body 10 since the exhaust grill portion 100 is arranged in front of the upper end portion of the main body 10. The front cover 120 may have the opening 104 formed thereon with a width to the extent that the filter unit 200 can go in and out to facilitate replacement of the filter unit 200. Further, the front cover 120 may have a hinge provided thereon so that the door 110 to be described later is rotatably coupled to the front cover 120. Specifically, the front cover 120 may have a pair of hinges formed to project from both edges of the opening 104 so that the door 110 can be coupled to both side walls 130 that are arranged inside the opening 104 to be rotated in upper and lower directions. In this case, it is described that the hinges are formed on the both side walls of the opening 104, but are not limited thereto. The hinges may be formed on both side surfaces of the door 110.

Further, the front cover 120 may be slantingly arranged so that the air in the flow path that is positioned in the rear can slowly change its flow direction from the rear of the exhaust grille portion 100 to the first exhaust port 102 and the second exhaust port 101 that are formed on the upper side thereof to be described later to be smoothly discharged, and the external air can slowly change its flow direction toward the suction flow path 51 that is positioned in the rear of the exhaust grille portion 100 through the suction port to be smoothly drawn into the suction flow path 51. As described above, the door 110 may be rotatably coupled to the lower side of the front cover 120 of the exhaust grille portion 100 so as to open/close the opening 104 that is formed on the front cover 120 of the exhaust grille portion 100 in an at least one of an opening or closing manner. Accordingly, the user can open the opening 104 by rotating the door 110 downward and close the opening 104 by rotating the door 110 upward.

On the other hand, the door 110 may be formed so that the door 110 can open or close the opening 104 only by a user's simple operation of pressing the door 110. Specifically, a hook 112 may be provided on the inner side surface of the door 110 and a latch member 111 may be provided on the front cover 120 of the exhaust grille portion 110 so that the hook 112 can be locked in or unlocked from the latch member 111. In contrast, the hook 112 may be provided on the front cover 120 of the exhaust grille portion 110, and the latch member 111 may be provided on the inner side surface of the door 110.

According to this construction, may not be necessary for the user to separate the exhaust grille portion 100 from the main body 10 to replace the filter unit 200, but the filter unit 200 can be replaced through the opening 104 that is formed on the front cover 120 of the exhaust grille portion 100 to increase usage convenience. On the other hand, the door 110 that is rotatably coupled to the lower side of the front cover 120 may be formed to be slidably drawn into the inside of the opening 104 in a state where the opening 104 is opened. This construction is to resolve the inconvenience that occurs due to interference of the opened door 110 with a user's arm when the user opens the door 110 to take the filter unit 200 to be replaced out of the wall mount type microwave oven 1 that is generally arranged at a fairly high position.

The plurality of vent holes may form the first exhaust port 102, the second exhaust port 101, and the first upper suction port 17. The first exhaust port 102 may be formed on the upper side of the center portion of the exhaust grille portion 100 to discharge the air in the first upper flow path 44 and the second upper flow path 45 to the upper side through the rear side of the exhaust grille portion 100. The second exhaust port 101 may be formed on the upper side of one end portion of the first exhaust port 102 to discharge the air in the exhaust flow path 52 to the upper side through the rear portion of the exhaust grille portion 100.

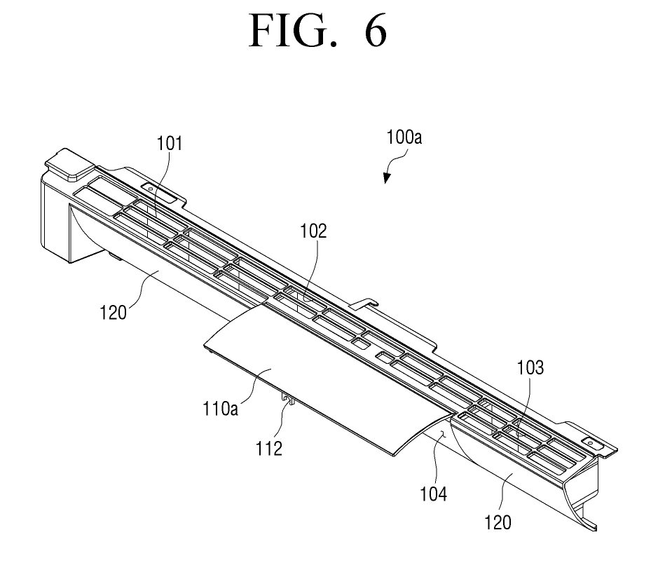

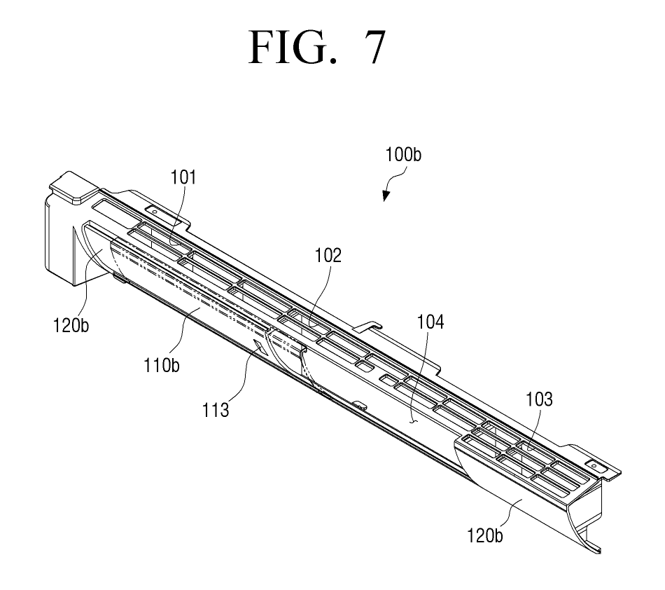

The second upper suction port 103 may be formed on the upper side of the other end portion of the first exhaust port 102 to discharge the external air to the suction flow path 51 through the rear portion of the exhaust grille portion 100 in association with the first upper suction port 17 as described above. Hereinafter, the exhaust grille portion 100 according to another embodiment will be described with reference to FIGS. 6 and 7. Explanation of the same construction will be omitted or reduced.

FIGS. 6 and 7 are perspective views illustrating exhaust grille portions 100 according to various embodiments. Referring to FIG. 6, in an exhaust grille portion 100a according to another embodiment, a door 110a may be rotatably coupled to the upper side of the front cover 120 of the exhaust grille portion 100a so that the door 110a can at least one of open or close the opening 104 in a sliding manner. Accordingly, the user can open the opening 104 by rotating the door 110a upward and close the opening 104 by rotating the door 110a downward. According to this construction, even if the wall mount type microwave oven 1 is arranged at a fairly high position, the user can easily replace the filter unit 200 without interfering with the door 110a.

Referring to FIG. 7, in an exhaust grille portion 100b according to still another embodiment, a door 110b may be formed on a front cover 120b to at least one of open or close the opening 104 in a sliding manner. That is, the exhaust grille portion 100b may be formed so that the door 110b opens/closes the opening 104 through the reciprocating sliding operation thereof on the front cover 120b. The door 110b may be provided with a concave portion 113 formed on an outer surface of the door 110b to increase a frictional force between the user's hand and the outer surface of the door 110b, and thus the user can easily make the door 110b slide.

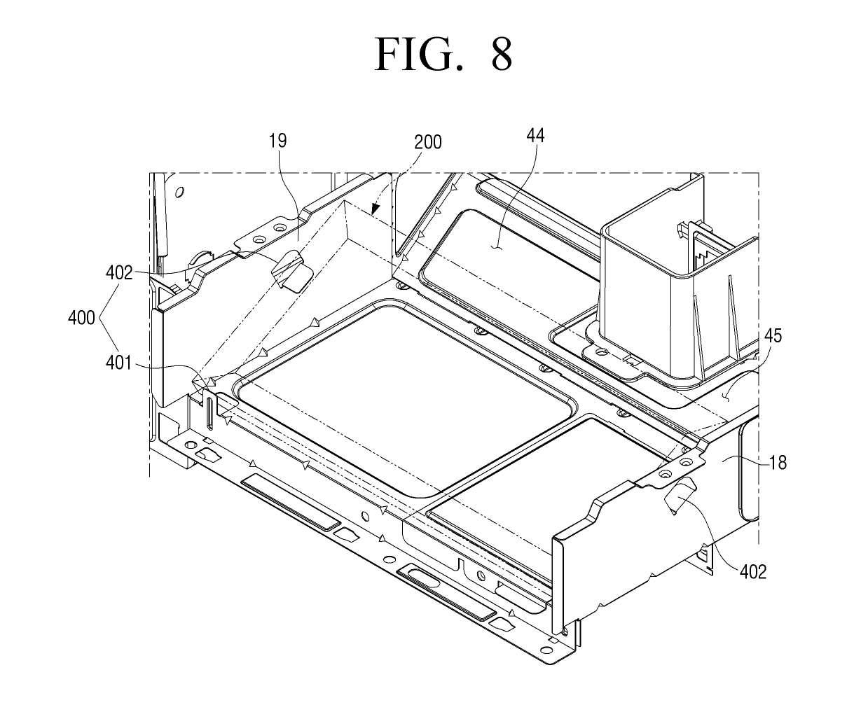

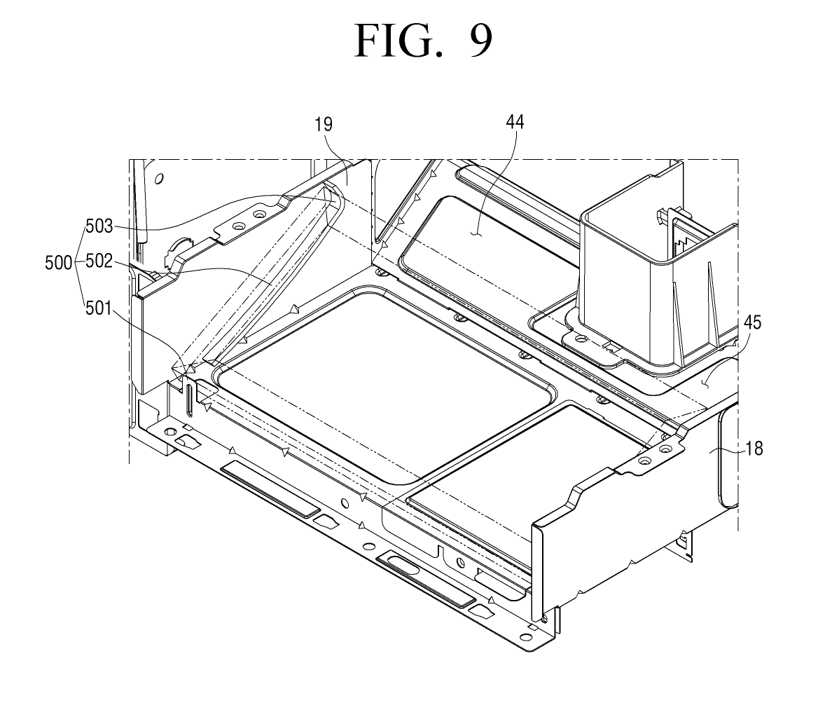

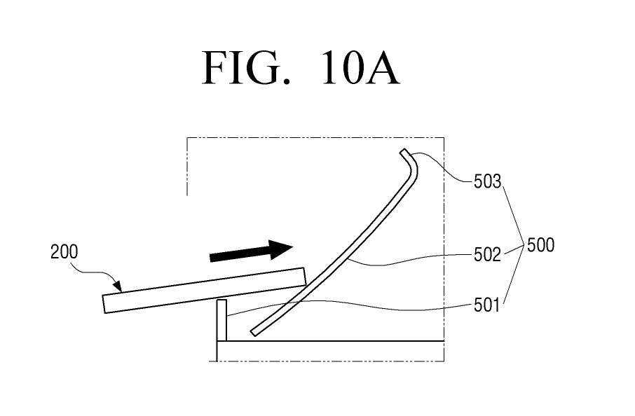

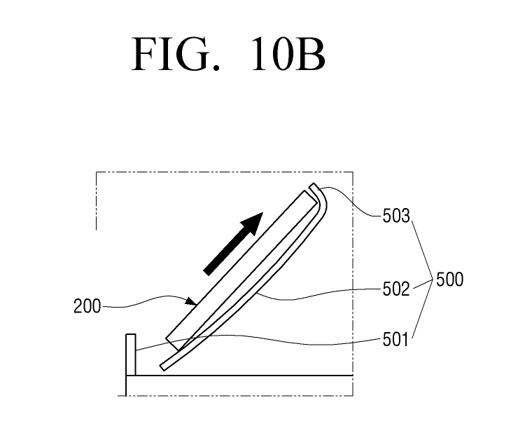

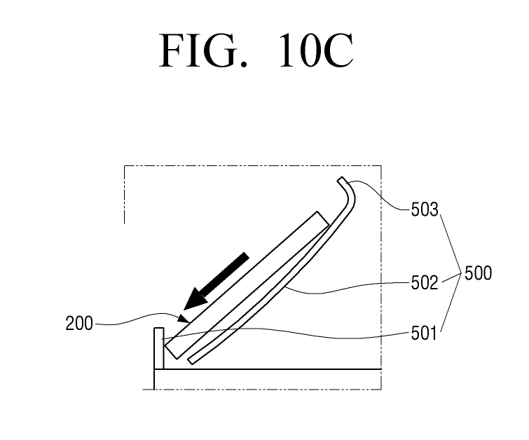

Hereinafter, the mount portion of the filter unit 200 will be described in detail. FIG. 8 is an enlarged perspective view illustrating a filter unit mount portion 400 formed in a flow path, and FIG. 9 is a perspective view illustrating a filter unit mount portion 400 according to another embodiment. FIGS. 10A, 10B, and 10C are views explaining mounting of a filter unit 200 on the filter unit mount portion 400 illustrated in FIG. 9.

Referring to FIG. 8, the filter unit mount portion 400 may be formed in a position that is adjacent to the opening 104 so that the user can easily replace the filter unit 200 through the opening 104 formed on the front cover 120 of the exhaust grille portion 100. Specifically, the filter unit mount portion 400 may include a catching ledge 401 formed to project upward to support the lower end portion of the filter unit 200, and a pair of support projections 402 formed to project toward the inside of the first partition plate 19 and the second partition plate 18 to support both sides of the filter unit 200 at positions which are spaced apart from the catching ledge 401 to the rear of the main body 10 and are higher than the catching ledge 401. Accordingly, when the filter unit 200 is mounted on the filter unit mount portion 400, the filter unit mount portion 400 can make the filter unit 200 arranged to be downwardly slanted toward the opening 104 of the exhaust grille portion 100. In other words, the filter unit mount portion 400 can make the filter unit 200 arranged to be downwardly slanted in a direction in which the filter unit 200 goes far toward the opening 104 of the exhaust grille portion 100.

Referring to FIG. 9, in a filter unit mount portion 500 according to another embodiment, a pair of support projections may be formed to extend in a rib shape in addition to the catching ledge 501 as described above. Specifically, each of the pair of support projections may include an extension portion 502 extending in a straight line or in a curve to be slanted upward from the catching ledge 501 to the rear of the main body 10, and a bent portion formed on an upper end of the extension portion 502 to be bent forward. Accordingly, the pair of support projections may be arranged to extend from the catching ledge 501 arranged on the lower side of the flow path to the upper side of the flow path.

According to the construction as described above, when the filter unit 200 is inserted through the opening 104 of the exhaust grille portion 100, the filter unit mount portion 500 guides the upper end portion of the filter unit 200 to the upper side of the flow path by means of the extension portions 502 of the pair of support projections, and thus the filter unit 200 can be slantingly arranged on the flow path. Accordingly, the filter unit mount portion 500 guides the filter unit 200 by means of the extension portions 502 of the pair of support projections while the filter unit 200 is inserted into the opening 104 of the exhaust grille portion 100 and then is slantingly arrange on the flow path, and thus the user convenience can be increased.

Further, even if the user strongly inserts the filter unit 200 rearward through the opening 104 of the exhaust grille portion 100, the filter unit mount portion 500 makes the filter unit 200 blocked by the bent portion 503 and easily mounted in a predetermined position without seceding from the position where the filter unit 200 is mounted. Specifically, referring to FIG. 10A, if the user holds and inserts the filter unit 200 through the opening 104 of the exhaust grille portion 100 in order to mount the filter unit 200 on the filter unit mount portion 400, the filter unit mount portion 500 makes the filter unit 200 positioned at one point of the extension portion 502 of the pair of support projections through interfering with the upper end portion of the filter unit 200 by means of the extension portion 502 of the pair of support projections.

Referring to FIG. 10B, if the user continues to apply a force to the filter unit 200 in a state where the user holds the filter unit 200 in order to move the filter unit 200 toward the filter unit mount portion 500, the filter unit mount portion 500 may guide the upper end portion of the filter unit 200 to the upper side of the flow path to slantingly arrange the filter unit 200 in the flow path. In this case, the filter unit 200 is slantingly arranged further upwardly than the predetermined mount position.

Referring to FIG. 10C, if the user releases the holding of the filter unit 200, the filter unit 200 minutely moves downward to be slantingly arranged and is mounted in the predetermined position of the filter unit mount portion 500.

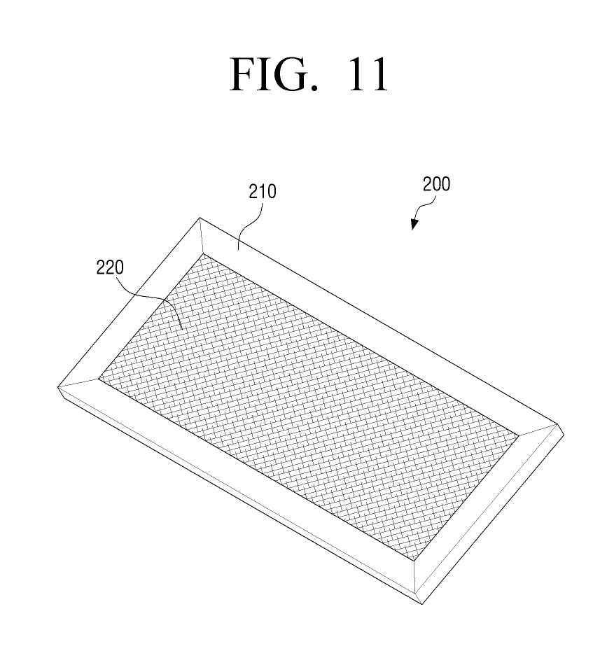

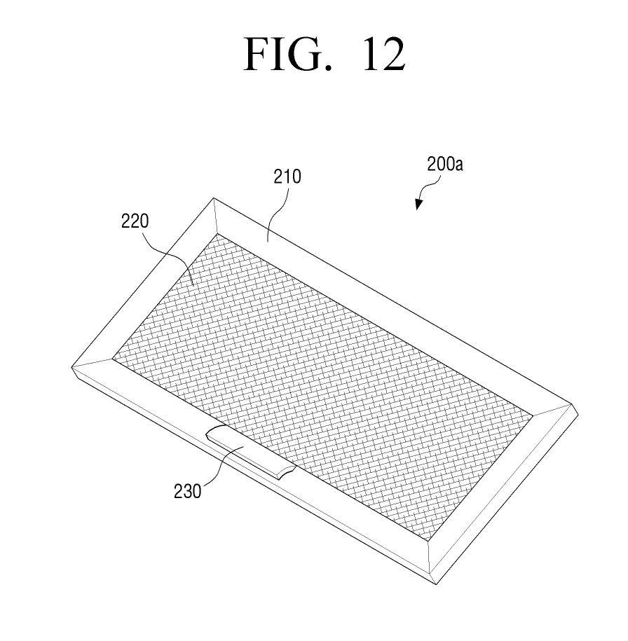

Hereinafter, the filter unit 200 will be described in detail with reference to FIGS. 11 and 12. FIG. 11 is a perspective view illustrating a filter unit 200 illustrated in FIG. 1, and FIG. 12 is a perspective view illustrating a filter unit 200a according to another embodiment.

Referring to FIG. 11, the filter unit 200 may include a rectangular filter frame 210 and a filter 220 installed on the filter frame 210. The filter unit 200 purifies polluted air that is polluted by gas and smoke generated through the use of the cooking device that is installed on the lower side of the wall mount type microwave oven 1. The filter unit 200 uses the filter 220 that is typically made of charcoal, and it is required to replace the filter 220 after the filter performs a predetermined capacity of filtering function. The filter unit 200 should be replaced in a predetermined period (of about 6 months).

Referring to FIG. 12, a filter unit 200a according to another embodiment may further include a handle 230 formed on the filter frame 210. In the case where the user holds and mounts the filter unit 200a on the filter unit mount portion 400, the user can easily replace the filter unit 200 through the handle 230 of the filter unit 200a.

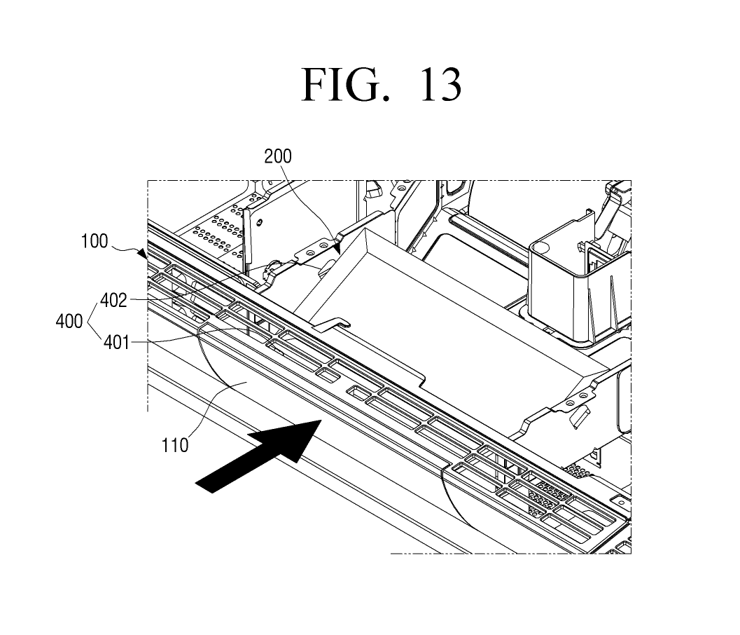

Hereinafter, a method for replacing a filter unit 200 of a wall mount type microwave oven will be described in detail with reference to FIGS. 13, 14, 15, 16, and 17. FIGS. 13, 14, 15, 16, and 17 are views explaining a replacement process of the filter unit 200. Referring to FIG. 13, in the case of replacing the filter unit 200 that is mounted on the filter unit mount portion 400 that is composed of the catching ledge 401 and a pair of support projections 402, the user pushes the upper end of the door 110 of the exhaust grille portion 100 in an arrow direction.

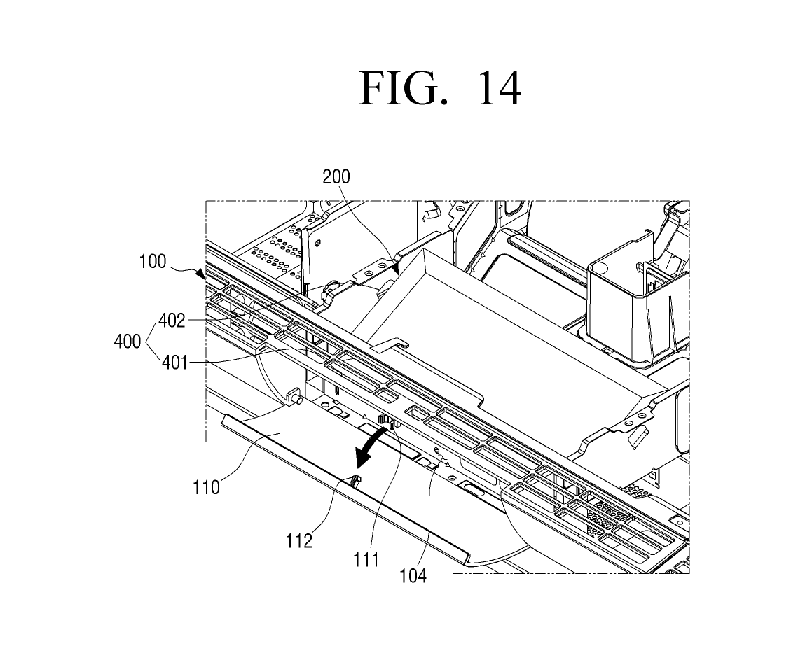

Referring to FIG. 14, as the hook 112 that is provided on the inner side surface of the door 110 and is in a locked state is unlocked from the latch member 111 that is provided on the front cover 120 of the exhaust grille portion 100 by the user's push operation, the door 110 is rotated downward to open the opening 104 that is formed on the front cover 120 of the exhaust grille portion 100.

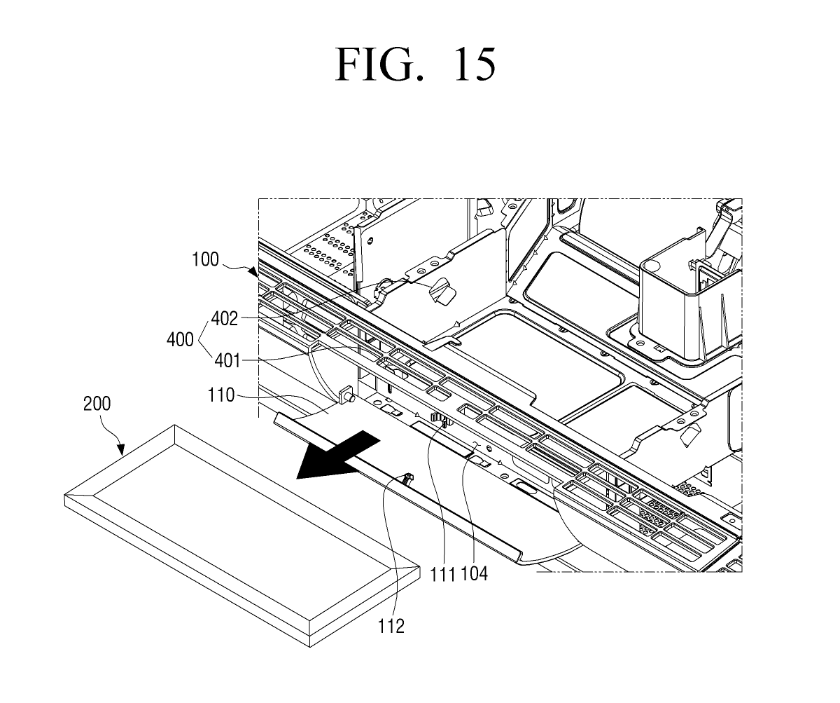

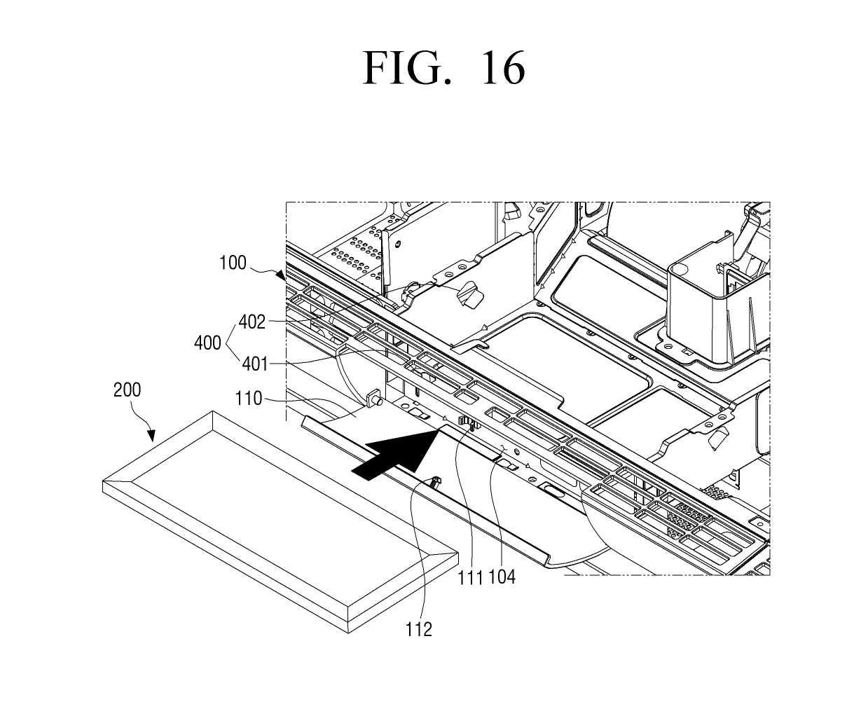

Referring to FIGS. 15 and 16, if the door 110 opens the opening 104 that is formed on the front cover 120 of the exhaust grille portion 100, the user draws the filter unit 200 mounted on the filter unit mount portion 400 out of the opening 104 in the direction of an arrow in FIG. 15, and then inserts a new filter unit 200 into the opening 104 in the direction of an arrow in FIG. 16 so as to mount the new filter unit 200 on the filter unit mount portion 400.

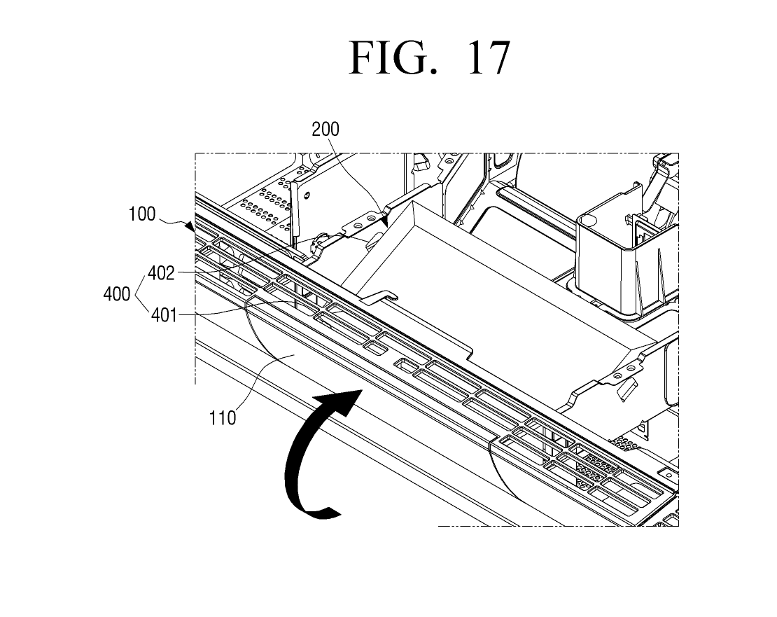

Referring to FIG. 17, if the filter unit 200 is mounted on the filter unit mount portion 400, the user pushes the door 110 that is provided on the front cover 120 of the exhaust grille portion 100 toward the opening 104 after rotating the door 110 in the direction of an arrow, and the hook 112 that is provided on the inner side surface of the door 110 is locked in the latch member 111 that is provided on the front cover 120 of the exhaust grille portion 100, so that the opening 104 is closed by the door 110.

As described above, according to the wall mount type microwave oven 1 according to the embodiments of the present disclosure, the filter unit 200 that is arranged on the flow path can be replaced without separating the exhaust grille portion 100 from the main body 10, and thus the user convenience can be improved. Further, according to the wall mount type microwave oven 1 according to the embodiments of the present disclosure, the rib-shaped support projections are provided on the filter unit mount portion 400 to guide the filter unit 200 up to the predetermined mount point of the filter unit mount portion 400, and thus the user convenience can be improved.

In the above-described embodiments, the wall mount type microwave oven is exemplified. However, the microwave oven according to the various embodiments as described above is not limited to the wall mount type.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A microwave oven comprising:
a main body having a suction port formed on one side thereof;
a flow path formed inside the main body and connected to the suction port;
a filter unit arranged within the flow path; and
an exhaust grille portion configured to form a part of the main body and provided with an exhaust port formed thereon, the exhaust port configured to exhaust air that is filtered through the filter unit, wherein the exhaust grille portion includes:
an opening formed on a front surface thereof and configured to permit a replacement of the filter unit, and
a door configured to perform at least one of opening or closing the opening.

2. The microwave oven as claimed in claim 1, wherein the door has left and right ends that are hinge-connected to a front cover of the exhaust grille portion that are configured to perform at least one of opening or closing the opening.

3. The microwave oven as claimed in claim 2, wherein hinge shafts provided at the left and right ends of the door are rotatably coupled to an upper side or a lower side of the front cover, and a hook provided on an inner side surface of the door is locked in or unlocked from a latch member provided on the front cover.

4. The microwave oven as claimed in claim 1, wherein the door is slidably coupled to a front cover of the exhaust grille portion to at least one of open or close the opening in a sliding manner.

5. The microwave oven as claimed in claim 1, wherein the flow path includes a filter unit mount portion configured to support the filter unit to be slantingly arranged, and wherein the filter unit mount portion includes a catching ledge configured to support a lower end portion of the filter unit, and a pair of support projections formed in a position that is higher than the catching ledge to support both sides of the filter unit.

6. The microwave oven as claimed in claim 5, wherein the pair of support projections extends slantingly in a rib shape.

7. The microwave oven as claimed in claim 6, wherein the pair of support projections comprises bent portions formed on upper ends thereof to be bent forward to prevent the filter unit from seceding backward.

8. The microwave oven as claimed in claim 1, wherein the filter unit comprises:
a filter frame having an opening formed in a center portion thereof;
a filter installed on the opening of the filter frame; and
a handle formed to extend from the filter frame.

9. A microwave oven comprising:
a main body having a suction port and an exhaust portion formed thereon;
a flow path formed inside the main body configured to connect the suction port and the exhaust portion to each other; and
a filter unit arranged on the flow path, wherein the main body includes:
an opening formed on a part of a front surface of the main body that is adjacent to the exhaust port to replace the filter unit, and
a door configured to at least one of open or close the opening.

10. The microwave oven as claimed in claim 9, wherein the door:
has left and right ends that are hinge-connected to the periphery of the opening to at least one of open or close the opening, or
is slidably coupled to the periphery of the opening to at least one of open or close the opening in a sliding manner.

11. The microwave oven as claimed in claim 9, wherein a filter unit mount portion formed in the flow path comprises:
a catching ledge configured to support a lower end portion of the filter unit; and
a pair of support projections extending slantingly in a rib shape to support both sides of the filter unit, wherein the pair of support projections include bent portions formed on upper ends thereof to be bent forward.

12. The microwave oven as claimed in claim 9, wherein the filter unit further comprises a handle formed on one portion thereof to draw out the filter unit through the opening.

13. An exhaust grill for a microwave oven, the exhaust grill comprising:
an exhaust port configured to exhaust air that is filtered through a filter unit;
an opening formed on a front surface thereof and configured to permit a replacement of the filter unit; and
a door configured to perform at least one of opening or closing the opening.

14. The exhaust grill as claimed in claim 13, wherein the door has left and right ends that are hinge-connected to a front cover of the exhaust grille that are configured to perform at least one of opening or closing the opening.

15. The exhaust grill as claimed in claim 13, wherein hinge shafts provided at the left and right ends of the door are rotatably coupled to an upper side or a lower side of a front cover, and a hook provided on an inner side surface of the door is locked in or unlocked from a latch member provided on the front cover.

16. The exhaust grill as claimed in claim 13, wherein the door is slidably coupled to a front cover of the exhaust grille portion to at least one of open or close the opening in a sliding manner.

17. The exhaust grill as claimed in claim 13, wherein the filter unit comprises:
a filter frame having an opening formed in a center portion thereof;
a filter installed on the opening of the filter frame; and
a handle formed to extend from the filter frame.
